(19) United States
(12) Patent Application Publication
(10) Pub. No.: US 2005/0201342 A1
(43) Pub. Date: Sep. 15, 2005

(54) Wireless access point network and management protocol

(76) Inventors: Randy Wilkinson, Chico, CA (US); Brock Eastman, Chico, CA (US); James A. Higgins, Chico, CA (US)

Correspondence Address: DLA PIPER RUDNICK GRAY CARY US LLP, 153 TOWNSEND STREET, SUITE 800, SAN FRANCISCO, CA, 94107-1907, US

(21) Appl. No.: 10/983,957

(22) Filed: Nov. 8, 2004

Related U.S. Application Data
(63) Continuation-in-part of application No. 10/108,021, filed on Mar. 27, 2002, now Pat. No. 6,831,921.

(51) Int. Cl. H04B 7/14; H04J 3/08; H04J 1/10; H04Q 7/24

(52) U.S. Cl. 370/338

(57) ABSTRACT

A wireless internet access network includes one or more relay points each configured for wireless communication with at least one other relay point or a gateway, or both. One or more computer premise equipment (CPE) points are configured for wireless communication with at least one of the relay points or another CPE point, or both. The computer premise equipment points comprise wireless access points that are configured for wireless communication with one or more wireless network access devices. The wireless access points include a wireless communications protocol configured for permitting the wireless network access devices to thereby connect to the network and communicate with other devices.

### PRIORITY

This patent application is a continuation-in-part application which claims priority to U.S. patent application Ser. No. 10/108,021, filed Mar. 27, 2002, now U.S. States published patent application No. 2003/0185169, and is related to U.S. patent application Ser. No. 10/859,448, filed Jun. 2, 2004, and each application is hereby incorporated by reference.

### BACKGROUND

1. Field of the Invention

The invention relates to wireless internet access networks, and particularly those having wireless access points and a wireless access point management protocol.

2. Description of the Related Art

According to IEEE 802.11, each BSS (Basic Service Set) that an AP (Access Point) provides is connected through a DS (Distribution Service) for a given ESS(Extended Service Set), which is left purposely undefined in the 802.11 specification. In the most common wireless network the DS is 802.3 or wired ethernet. In this scenario the AP is easily accessible and manageable, while still providing message delivery between APs and hence between the associated STAs of each AP.

It is recognized in the present invention, that in a wireless network that also includes wireless access points, the DS will also be wireless. Fortunately the 802.11 specification provides this WDS (Wireless Distribution Service) functionality through the use of an additional address field in the header. While this WDS link from AP to AP in combination with learning bridges and STP provides message delivery, what it lacks is management of the APs and the WDS. Typically in a WDS environment the AP to AP relationship with be a parent, child, or a master, slave, scenario where one of the Aps will be closer to a network resource or central hub within an ESS. The topology that results resembles a tree with branches, where one mismanaged AP or broken link will result in a failure of the WDS, and undelivered messages for that branch. Although WDS is subject to the same downfalls of wireless media that the STA to AP links are subject to, the 802.11 management frames were specifically designed for the Station to Access Point relationship. It is desired to have a wireless network including wireless access points and a wireless access point management protocol (WAMP) that features not only some of the management functionality of a WDS. In addition, it is desired to particularly provide a WAMP that has even more utility and is particularly configured for a wireless WDS enviornment.

### SUMMARY OF THE INVENTION

A triply wireless internet access network is provided that includes one or more relay points each configured for wireless communication with at least one other relay point or a gateway, or both. One or more computer premise equipment (CPE) points are each configured for wireless communication with at least one of the relay points or another CPE point, or both. Each of the computer premise equipment points comprises a wireless access point that is configured for wireless communication with one or more wireless network access devices.

The wireless access points include a wireless communications protocol configured for permitting the wireless network access devices to thereby connect to the network and communicate with another device. The preferred protocol includes a network signature beacon module for providing a wireless signal packet permitting the access point to ensure that it is connected to the network, as well as providing a distribution service for the wireless network access devices to receive. The network signature beacon module may include a network beacon validity determination module. The signal packet provided by the network signature beacon module may include network, access point or relay point information, or one or more authentication parameters, or combinations thereof. The network signature beacon module is preferably configured to permit propagation of an automatic change of channel.

The protocol may also include a status updates module for receiving network, relay point or access point information, or combinations thereof, and sending a name-value pair report to a central monitoring system. The name-value pair report may include access point environment information.

The protocol may further include a command interface module for receiving authentication parameters, accepting and authenticating a command-value pair, and executing the command. The command interface module may include an authorization process module, and is preferably configured to communicate one or more commands for triggering a channel change or send a status update, or both.

The protocol may also include a communications packet authentication module and/or an encryption module for encrypting messages that are communicated wirelessly between points of the network. The encryption module may include an error detection module, a cipher block chaining symmetric algorithm generating module that is configured to protect against message insertion techniques, and/or a key and initialization vector generating module that is configured for to permit key pre-sharing.

Methods are also provided for operating a wireless access point for permitting communications between a wireless network access device and another device having network access capability over a triply wireless network. The network includes one or more relay points each configured to communicate wirelessly with at least one other relay point or a gateway, or both. One or more computer premise equipment (CPE) points that each comprise at least one of the wireless access points are each configured for wireless communication with at least one of the relay points or another CPE point, or both. One or more processor readable storage devices are also provided having processor readable code embodied thereon. The processor readable code programs one or more processors to perform any of the methods.

### BRIEF DESCRIPTION OF THE DRAWINGS

FIG. 1 schematically illustrates a wireless network including wireless access points in accordance with a preferred embodiment.

FIG. 2 schematically illustrates a wireless access point customer premise equipment including a wireless access point that also includes an Ethernet connection.

FIG. 3A illustrates a 802.11 MAC header and FCS.

FIG. 3B illustrates a general MAC frame format.

FIG. 3C illustrates a frame control field.

FIG. 3D illustrates a sequence control field.

FIG. 3E illustrates an internet datagram header format.

FIG. 3F illustrates user datagram header format.

FIG. 4 is a block diagram illustrating a wireless access point management protocol in accordance with a preferred embodiment.

FIG. 5 is a block diagram illustrating an encryption module in accordance with a preferred embodiment.

FIG. 6 is a block diagram illustrating a status updates module in accordance with a preferred embodiment.

FIG. 7 is a block diagram illustrating a network signature beacon module in accordance with a preferred embodiment

FIG. 8 is a block diagram illustrating a command interface module in accordance with a preferred embodiment.

### DETAILED DESCRIPTION OF THE PREFERRED EMBODIMENTS

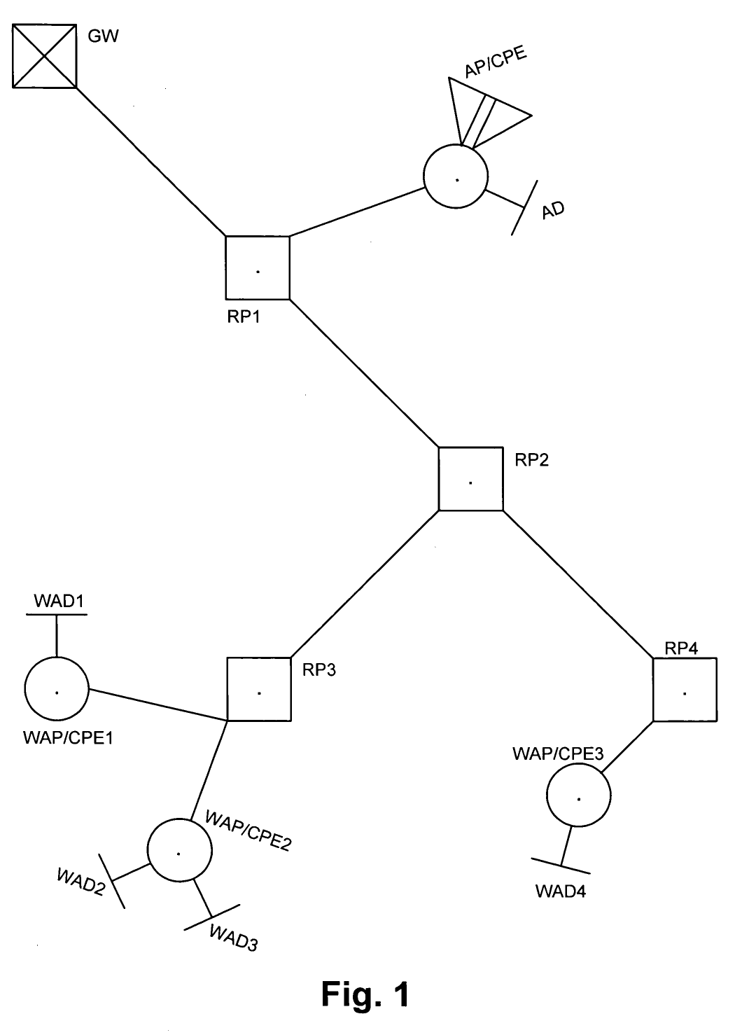

FIG. 1 schematically illustrates a wireless network including wireless access point CPEs in accordance with a preferred embodiment. A gateway GW is shown which is the path through which a device connect to the wireless network of the preferred embodiment to connect to another network such as the internet. A first relay point RP1 communicates wirelessly with the gateway and a second relay point RP2. The first relay point RP1 relays communications from the second relay point to the gateway, and vice-versa. Although not illustrated, any of the relay points RP1, RP2, RP3 and/or RP4 can also serve as an access point to which a wireless access device such as a 802.11 enabled laptop computer may connect to the network. The third relay point RP3 and the fourth relay point RP4 are each connected wirelessly to the second relay point RP2. This illustrates that a single relay point may receive communications from multiple downstream network points. In fact, the second relay point RP2, and others in the network, may be relaying communications from several downstream points contemporaneously. The protocol thus includes a contention prioritization scheme and programming, such as the tc and cbq modules of the Linux advance traffic shaper provided by open source, and alternatively as described in one or more of the other references cited herein or as understood by those skilled in the art.

The third relay point RP3 is illustrated in FIG. 1 as having a wireless connection to a downstream first wireless access point and customer premise equipment WAP/CPE1 and second wireless access point and customer premise equipment WAP/CPE2. The fourth relay point RP4 is illustrated as being connected to a third wireless access point and customer premise equipment WAP/CP3. Far more WAP/CPEs may be connected ultimately to the gateway GW or another gateway in an overall network that may scale tens or hundreds of miles or more, and may include hundreds of WAP/CPEs, RPs and multiple gateways, or more. Alternatively to the wireless access points WAP/CPE1, 2 and 3, an access point and customer premise equipment point AP/CPE may be wirelessly connected, e.g., to the first relay point RP1, while connection to the AP/CPE by a home PC, laptop or other computing device or otherwise network-accessible device, may be by Ethernet or other cable connection, such as may be described at United States published patent application No. 2003/00185169, and/or U.S. patent application Ser. No. 10/859,448, which are assigned to the same assignee as the present application and are hereby incorporated by reference.

A first wireless access device WAD1 is illustrated as being wireless connected to WAP/CPE1 in FIG. 1. The access may use 802.11 a/b/g technology, or 802.16, or another wireless network access RF technology, such as according to a standard or some innovative scheme that may arise in the future that may be used. Second and third wireless access devices WAD2 and WAD3 are each connected to WAP/CPE2, illustrating that multiple wireless access devices, such as handheld processor-based units, laptops, mobile terminal unit that may be installed in cars, boats, bikes, etc., may connect to WAP/CPE2 contemporaneously and communicate through the gateway GW via relay points RP3, RP2 and RP1. Although not shown, in the event that another gateway exists and, e.g., is connected wirelessly to relay point RP4, then communication via RP3, RP2 and RP4 through that other gateway would be possible, as well. A fourth wireless access device WAD4 is illustrated as being wireless connected to the network at WAP/CPE3.

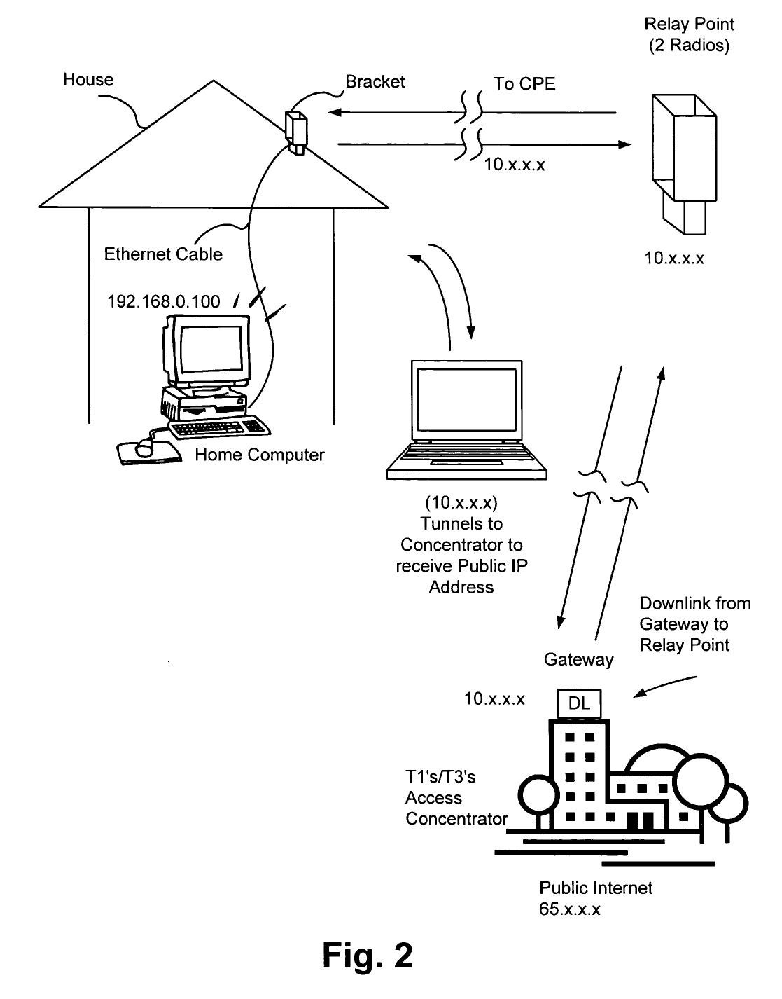

FIG. 2 is a schematic illustration of a gateway, a relay point wirelessly connected to the gateway, a WAP/CPE wireless connected to the relay point, and a laptop computer, handheld and/or portable computing device or other wireless access device WAD wirelessly connected to the WAP/CPE. An ethernet-connected home PC is illustrated as being cable connected to the same WAP/CPE and is thereby enabled to communicate through the relay point and gateway just as the WAD is. The relay point illustrated at FIG. 2 preferably communicates upstream to the gateway and/or to another relay point (not shown) by way of a directional signal connection generated by a directional antenna and associated electronics such as routing and/or bridging equipment. The WAP/CPE preferably communicates with the relay point via a directional signal. The relay point may use a directional or omni-directional signal for connecting with the WAP/CPE. The WAP/CPE may use an omni-directional signal to connect to an upstream relay point or another CPE that may be upstream or downstream, but the CPE would have to very close to the other CPE or to the relay point, and so in general, directional connections to relay points are preferred. There are many ways to connect sequential points on a wireless network, e.g., directional to directional, direction to omni-directional, omni-directional to directional and omni-directional to omni-directional, and any such ways understood by those skilled in the art may be used in preferred and alternative embodiments of the invention.

FIG. 2 illustrates that a same CPE may serve as a wireless access point and a have a cable connection for Ethernet access. A couple of radio signal input/output embodiments will now be described, wherein a CPE also serves as a wireless access point, e.g., such as the WAP/CPEs illustrated at FIG. 1 and the radio that the 802.11, 802.16 or otherwise wirelessly-configured laptop is connecting to in FIG. 2. In a first embodiment, the WAP/CPE includes only a single radio. The single radio includes primarily a directional signal component that is used to connect to an upstream relay point or another CPE for ultimately connecting through to a gateway. A wireless access device such as the WADs of FIG. 1 or the laptop of FIG. 2 may connect to the CPE using this directional component. The single radio further includes a quasi-omnidirectional component of generally far less extent (e.g., a couple or a few dB) than the directional component and having a somewhat irregular signal shape. However, a WAD may connect to the single radio CPE system using this omni-directional signal component.

In a second embodiment, the WAP/CPE includes two signal outputs, e.g., two systems that include an antenna and signal power source. Preferably, one of the radios will provide a substantially directional signal for connecting to an upstream relay point, gateway or another CPE. The other of the two radios then preferably provides a more regular, standardized, selected and/or uniform omni-directional output so that a WAD may connect, if it is close enough, anywhere within its 360° signal area. Of course, myriad arrangements are possible and may be configured to particularly address the space within which wireless access is desired, e.g., including a two radio system wherein both provide directional signals, a smart antenna that has a selected power distribution that may favor a particular direction or signal access area, and/or an upstream CPE connecting with a downstream CPE by omni-directional to omni-directional connection or by one or more directional signal connections.

### Communications Protocol

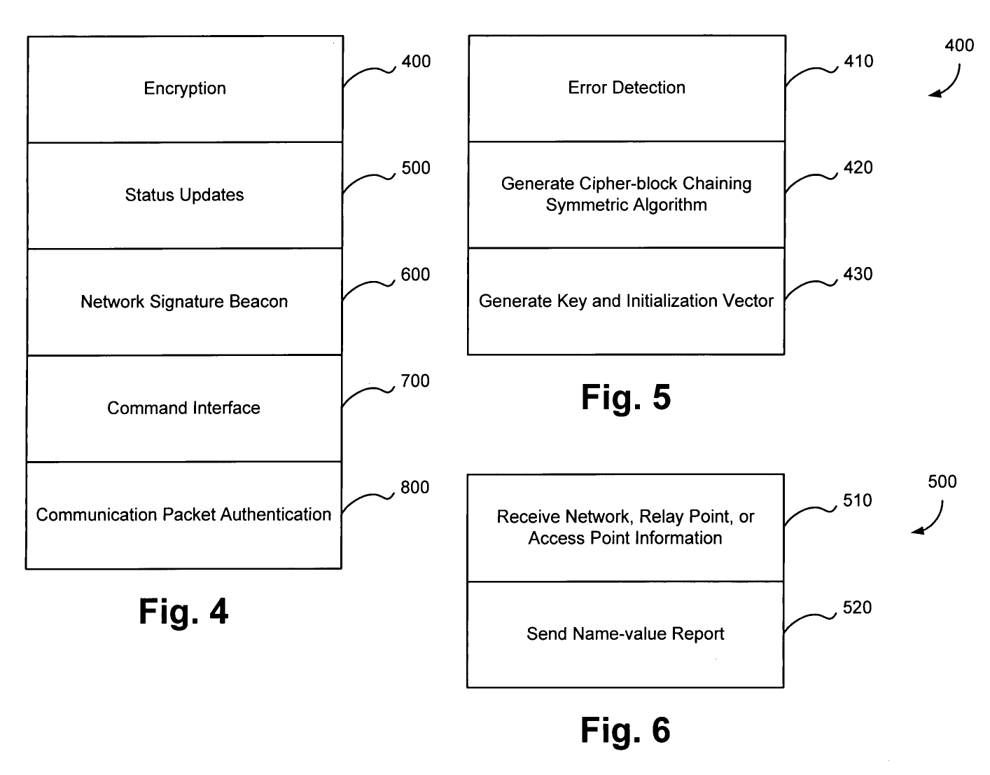

In any of the preferred or alternative embodiments described above or another configuration that may be possible for providing a “triply” wireless network including wireless relay points, CPEs and APs, a protocol is preferably provided as described in detail below. What follows is a description of a protocol according to a preferred embodiment which allows wireless access points to communicate and manage each other using encrypted UDP messages through an IP network in a bridged WDS environment. The three main management components of this protocol, referring to FIG. 4, are: network signature beacon module 600, status updates module 500, command interface module 700. The protocol preferably further includes an encryption module 400 and a communication packet authentication module 800. Alternatively, the module 800 may be included within the command interface module 700 or the command interface module 700 may communicate with an external authentication module 800. Also alternatively, there may be more than one authentication module, e.g., one for authenticating commands (e.g., any or all of modules 710, 720 and 750 of the command interface module 700 illustrated at FIG. 8) and another for authenticating other communications (e.g., module 800).

In short, the network signature beacon module 600 is the base function of the protocol and allows for channel synchronization and provides information to a parent network point, such as an upstream relay point, CPE or gateway, for subsequent status updates as well as additional authentication parameters for the command interface 700. Status updates generated by the status updates module 500 are preferably name-value pair reports sent to a parent point and are typically relayed up to a central monitoring system. The command interface 700 accepts command-value pairs from the parent, and authenticates and executes commands.

### Frame Format

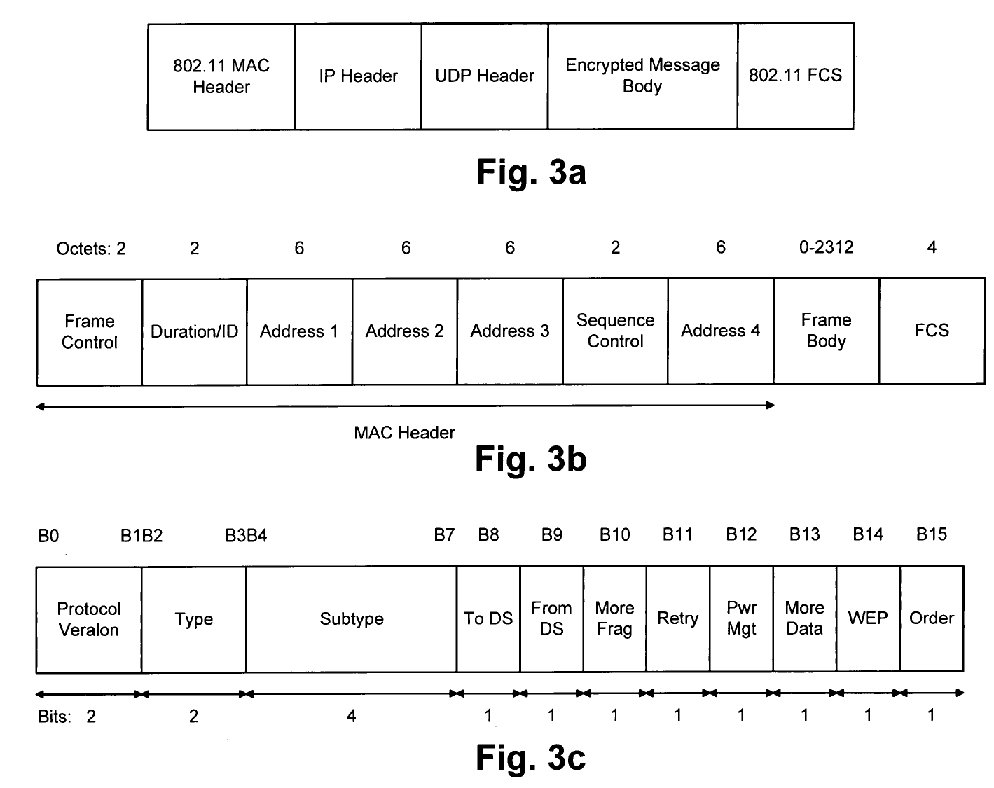

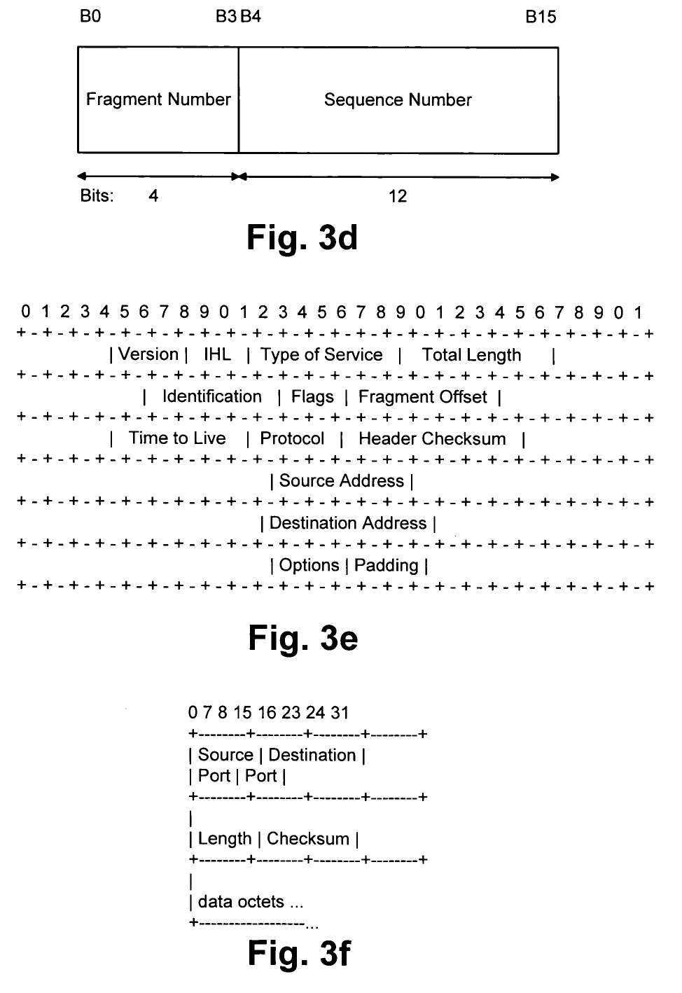

An efficient WAMP frame format including a 802.11 MAC header and FCS in accordance with a preferred embodiment is illustrated at FIG. 3A. It preferably includes the following four or five components. First is an 802.11 MAC header and FCS (which contains a 32 bit CRC). These may be separate components. Then, there is an IP header, a UDP header and an encrytped message body. The general frame format of the IEEE 802.11 MAC header and FCS is illustrated at FIG. 3B, in accordance with the IEEE 802.11 specification.

### Frame Fields

A frame control field preferably includes the following subfields: protocol version, type, subtype, to DS, from DS, more fragments, retry, power management, more data, wired equivalent privacy (WEP), and order. The format of the frame control field is illustrated at FIG. 3C.

A protocol version field in accordance with a preferred embodiment is 2 bits in length and is variant in size and placement across all revisions of this standard. For this standard, the value of the protocol version is 0. All other values are reserved. The revision level will be incremented only when a fundamental incompatibility exists between a new revision and the prior edition of the standard. A device that receives a frame with a higher revision level than it supports will discard the frame without indication to the sending station or to LLC.

A Type field in accordance with a preferred embodiment is 2 bits in length, and a Subtype field is 4 bits in length. The Type and Subtype fields together identify the function of the frame. There are three frame types: control, data, and management. Each of the frame types have several defined subtypes. Table 1 defines the valid combinations of type and subtype. A type subtype combination of relevance for the WAMP frame is the Data types that contain data. Table 1 is illustrative:

TABLE 1
Valid type and subtype combinations

| Type value | Type | Subtype value | |
|---|---|---|---|
| b3 b2 | description | b7 b6 b5 b4 | Subtype description |
| 10 | Data | 0000 | Data |
| 10 | Data | 0001 | Data + CF-Ack |
| 10 | Data | 0010 | Data + CF-Poll |
| 10 | Data | 0011 | Data + CF-Ack + CF-Poll |

A To DS field in accordance with a preferred embodiment is 1 bit in length and is set to 1 in data type frames destined for the DS. This includes all data type frames sent by STAs associated with an AP. The To DS field is set to 0 in all other frames. A preferred From DS field is 1 bit in length and is set to 1 in data type frames exiting the DS. It is set to 0 in all other frames. The permitted To/From DS bit combinations and their meanings are provided illustratively in Table 2 The ability to use wireless links for the DS is made possible by having the fourth address available:

TABLE 2
To/From DS combinations in data type frames

| To/From DS values | Meaning |
|---|---|
| To DS = 0 | A data frame direct from one STA to another STA |
| From DS = 0 | within the same IBSS; as well as all |
| | managaement and control type frames. |
| To DS = 1 | Data frame destined for the DS. |
| From DS = 0 | |
| To DS = 0 | Data frame exiting the DS. |
| From DS = 1 | |
| To DS = 1 | Wireless distribution system (WDS) frame, being |
| From DS = 1 | distributed from one AP to another AP. |

A preferred More Fragments field is 1 bit in length and is set to 1 in all data or management type frames that have another fragment of the current MSDU or current MMPDU to follow. It is set to 0 in all other frames.

A preferred retry field is 1 bit in length and is set to 1 in any data or management type frame that is a retransmission of an earlier frame. It is set to 0 in all other frames. A receiving station uses this indication to aid in the process of eliminating duplicate frames.

A preferred power management field is 1 bit in length and is used to indicate the power management mode of a STA. The value of this field remains constant in each frame from a particular STA within a frame exchange sequence defined in 9.7. The value indicates the mode in which the station will be after the successful completion of the frame exchange sequence. A value of 1 indicates that the STA will be in power-save mode. A value of 0 indicates that the STA will be in active mode. This field is always set to 0 in frames transmitted by an AP.

A preferred more data field is 1 bit in length and is used to indicate to a STA in power-save mode that more MSDUs, or MMPDUs are buffered for that STA at the AP. The more data field is valid in directed data or management type frames transmitted by an AP to an STA in power-save mode. A value of 1 indicates that at least one additional buffered MSDU, or MMPDU, is present for the same STA. The more data field may be set to 1 in directed data type frames transmitted by a contention-free (CF)-Pollable STA to the point coordinator (PC) in response to a CF-Poll to indicate that the STA has at least one additional buffered MSDU available for transmission in response to a subsequent CF-Poll. The more data field is set to 0 in all other directed frames. The more data field is set to 1 in broadcast/multicast frames transmitted by the AP, when additional broadcast/multicast MSDUs, or MMPDUs, remain to be transmitted by the AP during this beacon interval. The More Data field is set to 0 in broadcast/multicast frames transmitted by the AP when no more broadcast/multicast MSDUs, or MMPDUs, remain to be transmitted by the AP during this beacon interval and in all broadcast/multicast frames transmitted by non-AP stations.

A preferred WEP field is 1 bit in length. It is set to 1 if the Frame Body field contains information that has been processed by the WEP algorithm. The WEP field is only set to 1 within frames of type data and frames of type management, subtype authentication. The WEP field is set to 0 in all other frames. When the WEP bit is set to 1, the frame body field is expanded as defined below.

A preferred order field is 1 bit in length and is set to 1 in any data type frame that contains an MSDU, or fragment thereof, which is being transferred using the StrictlyOrdered service class. This field is set to 0 in all other frames.

A preferred duration/ID field is 16 bits in length. The contents of this field are as follows: In control type frames of subtype Power Save (PS)-Poll, the duration/ID field carries the association identity (AID) of the station that transmitted the frame in the 14 least significant bits (lsb), with the 2 most significant bits (msb) both set to 1. The value of the AID is in the range 1 2007. In all other frames, the duration/ID field contains a duration value as defined for each of the frame types. For frames transmitted during the contention-free period (CFP), the duration field is preferably set to 32 768. Whenever the contents of the duration/ID field are less than 32 768, the duration value is used to update the network allocation vector (NAV) according to the procedures defined in Clause 9. The encoding of the duration/ID field is illustrated in Table 3.

TABLE 3
Duration/ID field encoding

| Bit 15 | Bit 14 | Bits 13-0 | Usage |
|---|---|---|---|
| 0 | 0-32 767 | | Duration |
| 1 | 0 | 0 | Fixed value within frames transmitted |
| | | | during the CFP |
| 1 | 0 | 1-16 383 | Reserved |
| 1 | 1 | 0 | Reserved |
| 1 | 1 | 1-2 007 | AID in PS-Poll frames |
| 1 | 1 | 2008-16 383 | Reserved |

In the WDS enviornment the four address fields are what allow the bridges to forward packets. There are four address fields in the MAC frame format. These fields are used to indicate the BSSID, source address, destination address, transmitting station address, and receiving station address. The usage of the four address fields in each frame type is indicated by the abbreviations BSSID, DA, SA, RA, and TA, indicating basic service set identifier (BSSID), Destination Address, Source Address, Receiver Address, and Transmitter Address, respectively. Certain frames may not contain some of the address fields. Certain address field usage is specified by the relative position of the address field (1 4) within the MAC header, independent of the type of address present in that field. For example, receiver address matching is always performed on the contents of the address 1 field in received frames, and the receiver address of CTS and ACK frames is always obtained from the address 2 field in the corresponding RTS frame, or from the frame being acknowledged.

With regard to address representation, each address field preferably contains a 48-bit address as defined in 5.2 of IEEE Std 802-1990. With regard to address designation, a MAC sublayer address is preferably an individual address or a group address. An individual address is an address associated with a particular station on the network. A group address is a multi-destination address, associated with one or more stations on a given network. The two kinds of group addresses are multicast group address and broadcast address. A multicast-group address is an address associated by higher-level convention with a group of logically related stations. A broadcast address is a distinguished, predefined multicast address that denotes the set of all stations on a given LAN. All 1s in the destination address field are interpreted to be the broadcast address. This group is predefined for each communication medium to include stations actively connected to that medium; it is used to broadcast to all the active stations on that medium. Stations are able to recognize the broadcast address. It is not necessary that a station be capable of generating the broadcast address.

The address space is also partitioned into locally administered and universal (globally administered) addresses. The nature of a body and the procedures by which it administers these universal (globally administered) addresses is beyond the scope of this standard (but see IEEE Std 802-1990, hereby incorporated by reference, for more information).

A preferred BSSID field is a 48-bit field of the same format as an IEEE 802 MAC address. This field uniquely identifies each BSS. The value of this field, in an infrastructure BSS, is the MAC address currently in use by the STA in the AP of the BSS. The value of this field in an IBSS is a locally administered IEEE MAC address formed from a 46-bit random number. The individual/group bit of the address is set to 0. The universal/local bit of the address is set to 1. This mechanism is used to provide a high probability of selecting a unique BSSID. The value of all 1s is used to indicate the broadcast BSSID. A broadcast BSSID may only be used in the BSSID field of management frames of subtype probe request.

A preferred destination address (DA) field contains an IEEE MAC individual or group address that identifies the MAC entity or entities intended as the final recipient(s) of the MSDU (or fragment thereof) contained in the frame body field.

A preferred source address (SA) field contains an IEEE MAC individual address that identifies the MAC entity from which the transfer of the MSDU (or fragment thereof) contained in the frame body field was initiated. The individual/group bit is always transmitted as a zero in the source address.

A preferred receiver address (RA) field contains an IEEE MAC individual or group address that identifies the intended immediate recipient STA(s), on the WM, for the information contained in the frame body field.

A preferred transmitter address (TA) field contains an IEEE MAC individual address that identifies the STA that has transmitted, onto the WM, the MPDU contained in the frame body field. The Individual/Group bit is always transmitted as a zero in the transmitter address.

A preferred sequence control field is 16 bits in length and includes two subfields, the Sequence Number and the Fragment Number. The format of the Sequence Control field is illustrated in FIG. 3D.

A preferred sequence number field is a 12-bit field indicating the sequence number of an MSDU or MMPDU. Each MSDU or MMPDU transmitted by a STA is assigned a sequence number. Sequence numbers are assigned from a single modulo 4096 counter, starting at 0 and incrementing by 1 for each MSDU or MMPDU. Each fragment of an MSDU or MMPDU contains the assigned sequence number. The sequence number remains constant in all retransmissions of an MSDU, MMPDU, or fragment thereof.

A preferred fragment number field is a 4-bit field indicating the number of each fragment of an MSDU or MMPDU. The fragment number is set to zero in the first or only fragment of an MSDU or MMPDU and is incremented by one for each successive fragment of that MSDU or MMPDU. The fragment number remains constant in all retransmissions of the fragment.

A preferred frame body field is a variable length field that contains information specific to individual frame types and subtypes. The minimum frame body is 0 octets. The maximum length frame body is defined by the maximum length (MSDU+ICV+IV), where ICV and IV are the WEP fields.

A preferred FCS field is a 32-bit field containing a 32-bit CRC. The FCS is calculated over all the fields of the MAC header and the Frame Body field. These are referred to as the calculation fields. The FCS is calculated using the following standard generator polynomial of degree 32: G(×)=×32+×26+×23+×22+×16+×12+×11+×10+×8+×7+×5+×4+×2+×+1

The FCS is the 1 s complement of the sum (modulo 2) of the following: First, the remainder of ×k′ (×31+×30+×29+&+×2+×+1) divided (modulo 2) by G (×), where k is the number of bits in the calculation fields, and second, the remainder after multiplication of the contents (treated as a polynomial) of the calculation fields by ×32 and then division by G (×). The FCS field is transmitted commencing with the coefficient of the highest-order term. As a typical implementation, at the transmitter, the initial remainder of the division is preset to all 1 s and is then modified by division of the calculation fields by the generator polynomial G (×). The 1 s complement of this remainder is transmitted, with the highest-order bit first, as the FCS field.

At the receiver, the initial remainder is preset to all 1 s and the serial incoming bits of the calculation fields and FCS, when divided by G (×), results in the absence of transmission errors, in a unique nonzero remainder value. The unique remainder value is the polynomial: ×31+×30+×26+×25+×24+×18+×15+×14+×12+×11+×10+×8+×6+×5+×4+×3+×+1. An example of an IP header according to the RFC 760 is illustrated at FIG. 3E Each tick mark in FIG. 3E represents one bit position. For a detailed description of each field please refer to RFC 760.

### UDP Header

The UDP protocol is designed to provide the bare minimum required to send a datagram across a packet switched IP network. This is a connectionless protocol that does not guarantee delivery. The UDP header format illustrated at FIG. 3F is taken from RFC 768. A preferred User Datagram Header Format is described in detail at RFC 768, which is hereby incorporated by reference along with all other RFCs and standards cited herein.

### Program Architecture

As was introduced briefly above, FIG. 4 is a block diagram illustrating a wireless access point management protocol in accordance with a preferred embodiment. The program architecture includes an encryption module 400, a status updates module 500, a network signature beacon module 600, a command interface module 700 and a communications packet authentication module 800. FIGS. 5-8 schematically illustrate modules 400-700 in more detail. The particular sub-modules that are shown within each of the modules 400-700 in FIGS. 5-8 are merely preferred, and could be alternatively arranged in different or separate modules. Also, in a bare-bones system sufficient for providing wireless network access, the architecture may only include the network signature beacon module 600.

### Encryption

FIG. 5 is a block diagram illustrating an encryption module 400 in accordance with a preferred embodiment. The encryption module 400 preferably includes an error detection module 410, a cipher-block chaining symmetric algorithm 420 and a key and initialization vector generating module 430.

The message body of every WAMP packet is preferably encrypted. This provides some limited protection from packet sniffing and spoofing access points in our network. Ultimately the wireless media is inherently insecure and someone could intercept the WAMP packets and retransmit them, but each packet is preferably authenticated at module 800 and/or within a separate authentication module (not shown) within the encryption module. The encryption module 400 provides the error detection module 410, wherein if the packet becomes corrupt such that the message body would decrypt improperly, the packet will get discarded as an unauthentic packet.

The encryption algorithm includes preferably a Cipher Block Chaining, 128 bit, symmetric encryption routine 420. The Cipher Block Chaining 420 takes each 128 bit block and XORs it with the plain text of the next block so that if any of the blocks are out of place or corrupt the decryption will fail, this also protects against any message insertion techniques. The key and initialization vector module 430 provides the key and initialization vector as randomly generated and pre-shared items, which is why the symmetric encryption is preferred. While this is somewhat less secure than key negotiation and management, it does make the protocol more efficient. Also the pre-shared keys eliminates some of the common “man in the middle attacks” used on the current key negotiation schemes. Because of the speed of the algorithm, 128 bit Blowfish in CBC mode is desirable.

### Status Updates

FIG. 6 illustrates a block schematic of a status updates module 500 according to a preferred embodiment. The status updates module 500 includes a network, relay point or access point information receiving module 510 and a name-value report sending module 520.

The status updates module 500 generates reports that are sent to a parent network point. These status update reports are preferably contained within the message body of a network signature beacon signal. These reports include an encrypted string of comma separated name-value pairs, which contain current statistical information about that AP, and are sent on port 10076 (for a complete port mapping see table 4). Common values in a status update report would be information about the environment of the AP, such as noise, number of children, RSSI of the parent, current transmit power, speed test results to the parent, and any statistical information used for logging. This information can be used by the parent to make decisions about adjusting transmit power and channel through the command interface 700. Dynamically changing the transmit power and channel to improve a link is quite powerful, this allows networks to adjust to changing conditions.

The status update reports can also be propagated up to a central monitoring system, which will give an accurate idea of the current network status. Logging of statistics is also important for troubleshooting and seeing patterns in problematic links.

### Network Signature Beacon

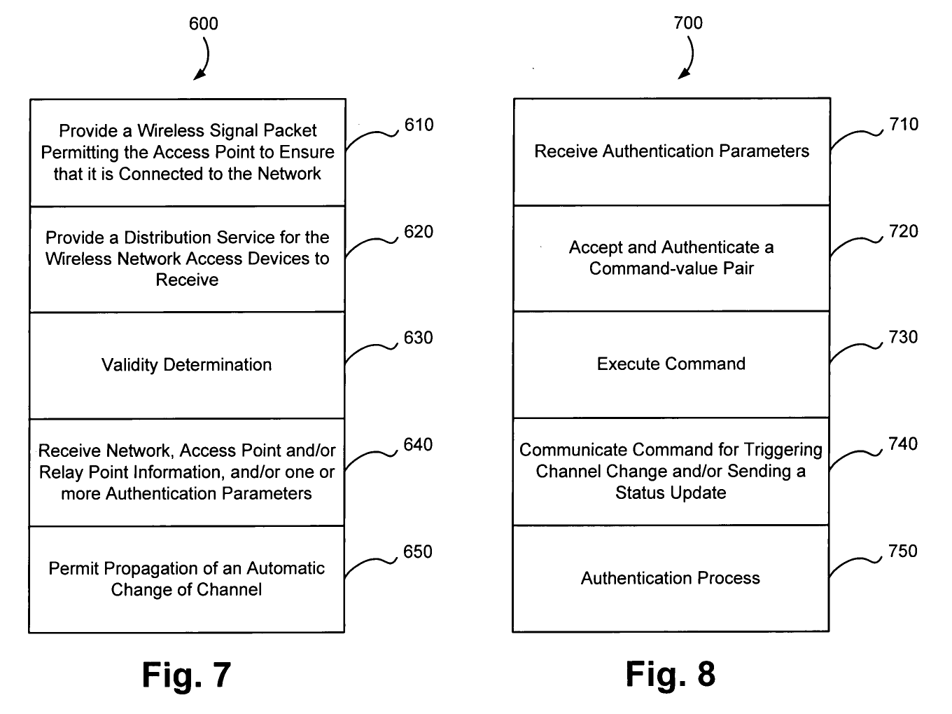

FIG. 7 illustrates a network signature beacon module 600 in accordance with a preferred embodiment. The module 600 preferably includes a module 610 for providing a wireless signal packet permitting an access point to ensure that it is connected to the network. Another module 62 provides a distribution service for the wireless network access devices to receive. Module 600 preferably further includes a validity determination module 630, a module 640 for receiving network, access point and/or relay point information and/or one or more authentication parameters, and a module 650 that permits propagation of an automatic change of channel.

The network signature beacon module 600 preferably generates a UDP packet and is set to broadcast at regular intervals so that an AP can be sure that it is connected to the WDS. If the AP does not receive a valid beacon from its parent within a timeout period, then the AP will preferably perform a site survey, change channels if warranted and attempt to reasscociate to the parent. This beacon uniquely identifies the WDS (Wireless Distribution Service) and allows the AP to seek out other APs on its WDS if its parent is no longer available. Once the AP has found a new parent, it can begin providing a DS for its stations and children again. This is made possible through the use of the IEEE 802.1d MAC bridging for each WDS link on each AP. Any beacons received that cannot be decrypted or are from a device other than its parent are discarded and do not reset the timeout period; these beacons would be considered invalid. The timeout period must be at least 2.5 times the beacon interval. This margin of error is preferred because UDP is connectionless and does not guarantee delivery.

This is an advantageous feature of the protocol. Other features of the protocol are preferably not made available until the first beacon has been received. The beacon carries encrypted information about the AP's parent, including the IP of the parent and the MAC address of the parent. The IP value of the parent is stored locally and used in generating the status update report which is preferably sent unicast back to the parent.

During installation of the AP, a site survey will be performed and the MAC address of the parent will be entered into the child. This MAC address will be compared to the decrypted MAC address in the message body of each beacon it receives. If these two MAC addresses match, then the network beacon signal is considered valid. Only valid beacons from the parent will reset the timeout period. The body of a typical network signature beacon communication will contain two values separated by commas: IP,MAC address (i.e. 10.0.201.105,00:04:E2:63:68:99).

Table 4 illustrates a port mapping for a communications protocol in accordance with a preferred embodiment. What is significant is that the network signature beacon, command interface and status update modules communicate by separate ports, e.g., ports A, B and C, respectively in Table 4.

TABLE 4

| Port | Communications Module |
|---|---|
| A | Network Signature Beacon |
| B | Command Interface |
| C | Status Updates |

These A, B and C designations are used to illustrate the point. The beacon, e.g., is sent out preferably on port 9076, the status update on port 10076, etc. By utilizing the separate ports, different filters may be used for the different modules. For example, it may be desired that the beacon be received by only a particular repeater, and so only a particular repeater would be configured at port A to receive the beacon, whereas it may be desired that any of multiple repeaters could receive a status updates communication, and so multiple repeaters would be configured at port C to receive the status update packet.

This beacon provides and ensures network connectivity and will allow for automatic channel change propagation through a timeout. If a parent should change its channel, then all of the children will timeout and site survey, change channels, and reassociate. The length of time this process takes is simply based on the value of the timeout period, if the reassociation should fail the AP will continue to timeout and repeat the process until a valid beacon is received.

### Command Interface

FIG. 8 illustrates a command interface module 700 in accordance with a preferred embodiment. The command interface module 700 preferably includes a module 710 for receiving authentication parameters, a module 720 for accepting and authenticating command-value pairs, a command execution module 730, a module 740 for communicating a command for triggering a channel change and/or sending a status update, and a process authentication module 750.

The command interface 700 is designed to allow the parent to execute commands on the child AP. The format is a comma separated list, “command,value,[value . . . ,]source IP,MAC address”, which is sent unicast to the child, and is also encrypted. The commands undergo an authorization process based on the IP in the network beacon and the MAC address entered by the installer. If the source IP and the MAC in the received decrypted command string match the IP contained in the valid Network Beacons and the MAC address entered by the installer then the command is considered valid. Once authenticated the commands will trigger specified actions to occur, for instance a channel change or to send an immediate status update. This ability to interact in real time with a specific ap allows for dynamic management of the wds links within an ESS. Based on the Status Updates a parent can use the command interface to manage its wds links to mitigate interference automatically. The management of APs within a WDS is advantageous for maintaining the integrity of the DS (Distribution Service) and therefore the coverage of the ESS (Extended Service Set) in a purely wireless network.

While an exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the appended claims and structural and functional equivalents thereof.

In addition, in methods that may be performed according to claims and/or preferred embodiments herein and that may have been described above and/or claimed below, the operations have been described and/or claimed in selected typographical sequences. However, the sequences have been selected and so ordered for typographical convenience and are not intended to imply any particular order for performing the operations, except for where a particular order may be expressly set forth or where those of ordinary skill in the art may deem a particular order to be necessary.

1. A wireless internet access network, comprising:
(a) one or more relay points each configured for wireless communication with at least one other relay point or a gateway, or both; and
(b) one or more computer premise equipment (CPE) points each configured for wireless communication with at least one of the relay points or another CPE point, or both; and
(c) wherein each of the computer premise equipment points comprises a wireless access point that is configured for wireless communication with one or more wireless network access devices.

2. The wireless network of claim 1, wherein each cpe point that comprises a wireless access point comprises a wireless communications protocol configured for permitting said wireless network access devices to thereby connect to the network and communicate with another device.

3. The wireless network of claim 2, wherein the protocol comprises a network signature beacon module for providing a wireless signal packet permitting the access point to ensure that it is connected to the network.

4. The wireless network of claim 3, wherein the network signature beacon module further provides a distribution service for the wireless network access devices to receive.

5. The wireless network of claim 4, wherein the protocol further comprises a status updates module for receiving network, relay point or access point information, or combinations thereof, and sending a name-value pair report to a central monitoring system.

6. The wireless network of claim 5, wherein the protocol further comprises a command interface module for receiving authentication parameters, accepting and authenticating a command-value pair, and executing the command.

7. The wireless network of claim 6, wherein the network signature beacon module, status updates module and command interface module are configured to communicate via separate ports.

8. The wireless network of claim 5, wherein the name-value pair report comprises access point environment information.

9. The wireless network of claim 4, wherein the protocol further comprises a command interface module for receiving authentication parameters, accepting and authenticating a command-value pair, and executing the command.

10. The wireless network of claim 9, wherein the command interface module comprises an authorization process module.

11. The wireless network of claim 9, wherein the command interface is configured to communicate one or more commands for triggering a channel change or send a status update, or both.

12. The wireless network of claim 4, further comprises a communications packet authentication module

13. The wireless network of claim 4, further comprising an encryption module for encrypting messages that are communicated wirelessly between points of the network.

14. The wireless network of claim 13, wherein the encryption module comprises an error detection module.

15. The wireless network of claim 13, wherein the encryption module comprises a cipher block chaining symmetric algorithm generating module that is configured to protect against message insertion techniques.

16. The wireless network of claim 13, wherein the encryption module comprises a key and initialization vector generating module.

17. The wireless network of claim 16, wherein the key and initialization vector generating module is configured to permit key pre-sharing.

18. The wireless network of claim 13, wherein the protocol further comprises a status updates module for receiving network, relay point or access point information, or combinations thereof, and sending a name-value pair report to a central monitoring system.

19. The wireless network of claim 18, wherein the protocol further comprises a command interface module for receiving authentication parameters, accepting and authenticating a command-value pair, and executing the command.

20. The wireless network of claim 13, wherein the protocol further comprises a command interface module for receiving authentication parameters, accepting and authenticating a command-value pair, and executing the command.

21. The wireless network of claim 4, wherein the network signature beacon module comprises a network beacon validity determination module.

22. The wireless network of claim 4, wherein the signal packet provided by the network signature beacon module comprises network, access point or relay point information, or one or more authentication parameters, or combinations thereof;

23. The wireless network of claim 4, wherein the network signature beacon module is configured to permit propagation of an automatic change of channel.

24. The wireless network of claim 3, wherein the protocol further comprises a status updates module for receiving network, relay point or access point information, or combinations thereof, and sending a name-value pair report to a central monitoring system.

25. The wireless network of claim 24, wherein the protocol further comprises a command interface module for receiving authentication parameters, accepting and authenticating a command-value pair, and executing the command.

26. The wireless network of claim 3, wherein the protocol further comprises a command interface module for receiving authentication parameters, accepting and authenticating a command-value pair, and executing the command.

27. The wireless network of claim 2, wherein the network signature beacon module further provides a distribution service for the wireless network access devices to receive.

28. The wireless network of claim 27, wherein the network signature beacon module comprises a network beacon validity determination module.

29. The wireless network of claim 27, wherein the signal packet provided by the network signature beacon module comprises network, access point or relay point information, or one or more authentication parameters, or combinations thereof;

30. The wireless network of claim 27, wherein the network signature beacon module is configured to permit propagation of an automatic change of channel.

31. The wireless network of claim 27, further comprises a communications packet authentication module

32. The wireless network of claim 27, wherein the protocol further comprises a status updates module for receiving network, relay point or access point information, or combinations thereof, and sending a name-value pair report to a central monitoring system.

33. The wireless network of claim 32, wherein the protocol further comprises a command interface module for receiving authentication parameters, accepting and authenticating a command-value pair, and executing the command.

34. The wireless network of claim 27, wherein the protocol further comprises a command interface module for receiving authentication parameters, accepting and authenticating a command-value pair, and executing the command.

35. The wireless network of claim 34, wherein the command interface module comprises an authorization process module.

36. The wireless network of claim 34, wherein the command interface is configured to communicate one or more commands for triggering a channel change or send a status update, or both.

37. One or more storage devices having processor readable code embodied thereon, said processor readable code for programming one or more processors to perform a method of operating a wireless access point for permitting communications between a wireless network access device and another device having network access capability over a triply wireless network that includes one or more relay points each configured to communicate wirelessly with at least one other relay point or a gateway, or both, and one or more computer premise equipment (CPE) points that each comprise at least one of the wireless access points and are each configured for wireless communication with at least one of the relay points or another CPE point, or both, the method comprising:
(a) providing a signal packet permitting the wireless access point to ensure that it is connected to the network; and
(b) providing a distribution service for the wireless network access devices to receive.

38. The one or more storage devices of claim 37, wherein the method further comprises:
(c) receiving network, relay point or access point information, or combinations thereof;
(d) sending a name-value pair report to a central monitoring system; and

39. The one or more storage devices of claim 38, wherein the name-value pair report comprises access point environment information.

40. The one or more storage devices of claim 39, wherein the access point environment information comprises information regarding noise, number of children, parent RSSI, current transmit power, parent speed test results or statistical information used for logging, or combinations thereof.

41. The one or more storage devices of claim 39, wherein the access point environment information is usable by the parent to make decisions about adjusting transmit power or channel change, or both.

42. The one or more storage devices of claim 38, wherein the method further comprises:
(e) receiving authentication parameters,
(f) accepting and authenticating a command-value pair, and
(g) executing the command.

43. The one or more storage devices of claim 37, wherein the method further comprises:
(c) receiving authentication parameters,
(d) accepting and authenticating a command-value pair, and
(e) executing the command.

44. The one or more storage devices of claim 37, wherein the method further comprises authenticating a communications packet.

45. The one or more storage devices of claim 37, wherein the method further comprises encrypting messages that are communicated wirelessly between points of the network.

46. The one or more storage devices of claim 45, wherein the method further comprises error detecting.

47. The one or more storage devices of claim 45, wherein the method further comprises generating a cipher block chaining symmetric algorithm that is configured to protect against message insertion techniques.

48. The one or more storage devices of claim 45, wherein the method further comprises generating a key and initialization vector.

49. The one or more storage devices of claim 48, wherein the key and initialization vector generating permits key pre-sharing.

50. The one or more storage devices of claim 37, wherein the method further comprises validity determining.

51. The one or more storage devices of claim 37, wherein the provided signal packet comprises information about the network, an access point or a relay point, or combinations thereof, or one or more authentication parameters, or both;

52. The one or more storage devices of claim 37, wherein the method further comprises automatically changing channel.

53. The one or more storage devices of claim 37, wherein the method further comprises authorization processing.

54. The one or more storage devices of claim 37, wherein the method further comprises communicating one or more commands for triggering a channel change or sending a status update, or both.

55. A method of operating a wireless access point for permitting communications between a wireless network access device and another device having network access capability over a triply wireless network that includes one or more relay points each configured to communicate wirelessly with at least one other relay point or a gateway, or both, and one or more computer premise equipment points that each comprise at least one of the wireless access points and are each configured for wireless communication with at least one of the relay points or another CPE point, or both, the method comprising:
(a) providing a signal packet permitting the wireless access point to ensure that it is connected to the network; and
(b) providing a distribution service for the wireless network access devices to receive.

56. The method of claim 55, further comprising:
(c) receiving network, relay point or access point information, or combinations thereof;
(d) sending a name-value pair report to a central monitoring system; and

57. The method of claim 56, wherein the name-value pair report comprises access point environment information.

58. The method of claim 57, wherein the access point environment information comprises information regarding noise, number of children, parent RSSI, current transmit power, parent speed test results or statistical information used for logging, or combinations thereof.

59. The method of claim 56, wherein the access point environment information is usable by the parent to make decisions about adjusting transmit power or channel change, or both.

60. The method of claim 56, further comprising:
(e) receiving authentication parameters,
(f) accepting and authenticating a command-value pair, and
(g) executing the command.

61. The method of claim 55, further comprising:
(c) receiving authentication parameters,
(d) accepting and authenticating a command-value pair, and
(e) executing the command.

62. The method of claim 55, further comprising authenticating a communications packet.

63. The method of claim 55, further comprising encrypting messages that are communicated wirelessly between points of the network.

64. The method of claim 63, further comprising error detecting.

65. The method of claim 63, further comprising generating a cipher block chaining symmetric algorithm that is configured to protect against message insertion techniques.

66. The method of claim 63, further comprising generating a key and initialization vector.

67. The method of claim 66, wherein the key and initialization vector generating permits key pre-sharing.

68. The method of claim 55, further comprising validity determining.

69. The method of claim 55, wherein the provided signal packet comprises information about the network, an access point or a relay point, or combinations thereof, or one or more authentication parameters, or both;

70. The method of claim 55, further comprising automatically changing channel.

71. The method of claim 55, further comprising authorization processing.

72. The method of claim 55, further comprising communicating one or more commands for triggering a channel change or sending a status update, or both.

73. A communications protocol for a wireless network that includes customer premise equipment (CPE) points connected wirelessly to one or more relay points or other CPEs, and also permitting wireless access devices to connect wirelessly to the network, the protocol permitting the wireless network access devices to connect to the network and communicate with another network-accessible device.

74. The communications protocol of claim 73, comprising a network signature beacon module that provides a wireless signal packet permitting the access point to ensure that it is connected to the network.

75. The communications protocol of claim 74, wherein the network signature beacon module further provides a distribution service for the wireless network access devices to receive.

76. The communications protocol of claim 75, further comprising a status updates module for receiving network, relay point or access point information, or combinations thereof, and sending a name-value pair report to a central monitoring system.

77. The communications protocol of claim 76, further comprising a command interface module for receiving authentication parameters, accepting and authenticating a command-value pair, and executing the command.

78. The wireless network of claim 77, wherein the network signature beacon module, status updates module and command interface module are configured to communicate via separate ports.

79. The communications protocol of claim 76, wherein the name-value pair report comprises access point environment information.

80. The communications protocol of claim 75, further comprising a command interface module for receiving authentication parameters, accepting and authenticating a command-value pair, and executing the command.

81. The communications protocol of claim 80, wherein the command interface module comprises an authorization process module.

82. The communications protocol of claim 80, wherein the command interface is configured to communicate one or more commands for triggering a channel change or send a status update, or both.

83. The communications protocol of claim 75, further comprises a communications packet authentication module

84. The communications protocol of claim 75, further comprising an encryption module for encrypting messages that are communicated wirelessly between points of the network.

85. The communications protocol of claim 84, wherein the encryption module comprises an error detection module.

86. The communications protocol of claim 84, wherein the encryption module comprises a cipher block chaining symmetric algorithm generating module that is configured to protect against message insertion techniques.

87. The communications protocol of claim 84, wherein the encryption module comprises a key and initialization vector generating module.

88. The communications protocol of claim 87, wherein the key and initialization vector generating module is configured to permit key pre-sharing.

89. The communications protocol of claim 84, further comprising a status updates module for receiving network, relay point or access point information, or combinations thereof, and sending a name-value pair report to a central monitoring system.

90. The communications protocol of claim 89, further comprising a command interface module for receiving authentication parameters, accepting and authenticating a command-value pair, and executing the command.

91. The communications protocol of claim 84, further comprising a command interface module for receiving authentication parameters, accepting and authenticating a command-value pair, and executing the command.

92. The communications protocol of claim 75, wherein the network signature beacon module comprises a network beacon validity determination module.

93. The communications protocol of claim 75, wherein the signal packet provided by the network signature beacon module comprises network, access point or relay point information, or one or more authentication parameters, or combinations thereof;

94. The communications protocol of claim 75, wherein the network signature beacon module is configured to permit propagation of an automatic change of channel.

95. The communications protocol of claim 74, further comprising a status updates module for receiving network, relay point or access point information, or combinations thereof, and sending a name-value pair report to a central monitoring system.

96. The communications protocol of claim 95, further comprising a command interface module for receiving authentication parameters, accepting and authenticating a command-value pair, and executing the command.

97. The communications protocol of claim 95, further comprising a command interface module for receiving authentication parameters, accepting and authenticating a command-value pair, and executing the command.

98. The communications protocol of claim 94, wherein the network signature beacon module further provides a distribution service for the wireless network access devices to receive.

99. The communications protocol of claim 98, wherein the network signature beacon module comprises a network beacon validity determination module.

100. The communications protocol of claim 98, wherein the signal packet provided by the network signature beacon module comprises network, access point or relay point information, or one or more authentication parameters, or combinations thereof;

101. The communications protocol of claim 98, wherein the network signature beacon module is configured to permit propagation of an automatic change of channel.

102. The communications protocol of claim 98, further comprising a communications packet authentication module

103. The communications protocol of claim 98, further comprising a status updates module for receiving network, relay point or access point information, or combinations thereof, and sending a name-value pair report to a central monitoring system.

104. The communications protocol of claim 103, further comprising a command interface module for receiving authentication parameters, accepting and authenticating a command-value pair, and executing the command.

105. The communications protocol of claim 98, further comprising a command interface module for receiving authentication parameters, accepting and authenticating a command-value pair, and executing the command.

106. The communications protocol of claim 105, wherein the command interface module comprises an authorization process module.

107. The communications protocol of claim 110, wherein the command interface is configured to communicate one or more commands for triggering a channel change or send a status update, or both.

108. The communications protocol of claim 73, comprising a network signature beacon module that provides a distribution service for the wireless network access devices to receive.

109. The communications protocol of claim 108, further comprising a status updates module for receiving network, relay point or access point information, or combinations thereof, and sending a name-value pair report to a central monitoring system.

110. The communications protocol of claim 109, further comprising a command interface module for receiving authentication parameters, accepting and authenticating a command-value pair, and executing the command.

111. The communications protocol of claim 109, wherein the name-value pair report comprises access point environment information.

112. The communications protocol of claim 108, further comprising a command interface module for receiving authentication parameters, accepting and authenticating a command-value pair, and executing the command.

113. The communications protocol of claim 112, wherein the command interface module comprises an authorization process module.

114. The communications protocol of claim 112, wherein the command interface is configured to communicate one or more commands for triggering a channel change or send a status update, or both.

115. The communications protocol of claim 108, further comprises a communications packet authentication module

116. The communications protocol of claim 108, further comprising an encryption module for encrypting messages that are communicated wirelessly between points of the network.

117. The communications protocol of claim 116, wherein the encryption module comprises an error detection module.

118. The communications protocol of claim 116, wherein the encryption module comprises a cipher block chaining symmetric algorithm generating module that is configured to protect against message insertion techniques.

119. The communications protocol of claim 116, wherein the encryption module comprises a key and initialization vector generating module.

120. The communications protocol of claim 119, wherein the key and initialization vector generating module is configured to permit key pre-sharing.

121. The communications protocol of claim 116, further comprising a status updates module for receiving network, relay point or access point information, or combinations thereof, and sending a name-value pair report to a central monitoring system.

122. The communications protocol of claim 121, further comprising a command interface module for receiving authentication parameters, accepting and authenticating a command-value pair, and executing the command.

123. The communications protocol of claim 116, further comprising a command interface module for receiving authentication parameters, accepting and authenticating a command-value pair, and executing the command.

124. The communications protocol of claim 108, wherein the network signature beacon module comprises a network beacon validity determination module.

125. The communications protocol of claim 108, wherein the signal packet provided by the network signature beacon module comprises network, access point or relay point information, or one or more authentication parameters, or combinations thereof;

126. The communications protocol of claim 108, wherein the network signature beacon module is configured to permit propagation of an automatic change of channel.
